(19) United States
(12) Patent Application Publication
(10) Pub. No.: US 2026/0138424 A1
(43) Pub. Date: May 21, 2026

(54) VEHICLE SIDE STRUCTURE

(71) Applicant: TOYOTA JIDOSHA KABUSHIKI KAISHA, Toyota-shi (JP)

(72) Inventors: Tetsuo NURUKI, Toyota-shi (JP); Takehiro Ito, Nisshin-shi (JP); Norihiro Murashige, Nisshin-shi (JP)

(73) Assignee: TOYOTA JIDOSHA KABUSHIKI KAISHA, Toyota-shi (JP)

(21) Appl. No.: 19/379,538

(22) Filed: Nov. 4, 2025

(30) Foreign Application Priority Data
Nov. 21, 2024 (JP) 2024-203256

(51) Int. Cl. B60J 5/04

(52) U.S. Cl. CPC B60J 5/0443; B60J 5/0429

(57) ABSTRACT

A door impact beam is disposed in a rear side door and extends along a vehicle front-rear direction. A rear frame body is made by die casting, and includes a lower side frame portion constituting at least a part of a lower portion of a rear side frame portion that constitutes a rear side door opening portion, a vertical wall portion erected from the lower side frame portion and disposed at a position overlapping an end portion of the door impact beam in a longitudinal direction in a vehicle side view, and a rear wheel house portion provided rearward of the lower side frame portion in the vehicle front-rear direction.

### CROSS-REFERENCE TO RELATED APPLICATION

This application claims priority to Japanese Patent Application No. 2024-203256 filed on November 21, 2024. The disclosure of the above-identified application, including the specification, drawings, and claims, is incorporated by reference herein in its entirety.

### BACKGROUND

### 1. Technical Field

The present disclosure relates to a vehicle side structure.

### 2. Description of Related Art

A structure in which a door impact beam is provided inside a side door in a vehicle side portion is known (for example, see Japanese Unexamined Patent Application Publication No. 2009-227064 (JP 2009-227064 A) and Japanese Unexamined Patent Application Publication No. 9-86178 (JP 9-86178 A)).

### SUMMARY

However, there is room for improvement in restraining the door impact beam from moving toward a vehicle cabin side at the time of side collision.

An object of the present disclosure is to obtain a vehicle side structure capable of restraining the door impact beam from moving toward the vehicle cabin side at the time of the side collision, in consideration of the above fact.

A vehicle side structure according to a first aspect includes a door impact beam disposed in a rear side door that opens and closes a rear side door opening portion and extending along a vehicle front-rear direction, and a rear frame body made by die casting, the rear frame body including a lower side frame portion constituting at least a part of a lower portion of a rear side frame portion that constitutes the rear side door opening portion, a vertical wall portion erected from the lower side frame portion and disposed at a position overlapping an end portion of the door impact beam in a longitudinal direction in a vehicle side view, and a rear wheel house portion provided rearward of the lower side frame portion in the vehicle front-rear direction.

In addition, the concept of "extending along the vehicle front-rear direction" includes a case of extending in the vehicle front-rear direction, as well as a case of extending to be inclined to one side in a vehicle up-down direction toward the vehicle rear side and being able to be recognized as extending along the vehicle front-rear direction.

With the vehicle side structure according to the first aspect, the door impact beam is disposed in the rear side door that opens and closes the rear side door opening portion and extends along the vehicle front-rear direction. The rear frame body includes the lower side frame portion constituting at least the part of the lower portion of the rear side frame portion that constitutes the rear side door opening portion, and the vertical wall portion erected from the lower side frame portion and disposed at the position overlapping the end portion of the door impact beam in the longitudinal direction in the vehicle side view. At the time of the side collision, the collision load may be input to the rear side door. In this case, the door impact beam that moves toward the vehicle cabin can be supported by the vertical wall portion, and the collision load transmitted from the door impact beam side to the vertical wall portion side can be transmitted to the lower side frame portion. Here, the rear frame body is further provided with the rear wheel house portion provided rearward of the lower side frame portion in the vehicle front-rear direction, and is made by die casting. Therefore, it is possible to efficiently transmit a part of the collision load transmitted to the vertical wall portion at the time of the side collision to the rear wheel house portion side. As a result, movement of the door impact beam toward the vehicle cabin can be restrained.

In the vehicle side structure according to a second aspect, in the configuration according to the first aspect, the end portion of the door impact beam in the longitudinal direction is fixed to a body portion of the rear side door via a bracket made of a sheet metal; and the vertical wall portion is disposed at a position overlapping at least a part of the bracket in the vehicle side view.

At the time of the side collision, the collision load may be input to the rear side door. In this case, with the vehicle side structure according to the second aspect, since the load can be transmitted to the vertical wall portion via the bracket, it is possible to increase the area of the portion that transmits the load to the vertical wall portion, and the load transmission efficiency is improved.

In the vehicle side structure according to a third aspect, in the configuration according to the second aspect, the bracket includes a beam support portion disposed at a position overlapping a part of the door impact beam in the vehicle side view and including a first fixed portion fixed to the door impact beam, and side portions disposed continuously with the beam support portion, the side portions being each disposed on a corresponding one of both sides of the door impact beam in a direction intersecting the longitudinal direction in the vehicle side view, and including a second fixed portion fixed to the body portion of the rear side door, and the vertical wall portion includes a portion overlapping an intersection of a center line along the longitudinal direction of the door impact beam and a line segment connecting the second fixed portion of a first side portion and the second fixed portion of a second side portion of the two side portions in the vehicle side view.

With the vehicle side structure according to the third aspect, the beam support portion of the bracket is disposed at the position overlapping the part of the door impact beam in the vehicle side view and includes the first fixed portion fixed to the door impact beam. In addition, the side portion of the bracket is disposed continuously with the beam support portion on both sides of the door impact beam in the direction intersecting the longitudinal direction in the vehicle side view and includes the second fixed portion fixed to the body portion of the rear side door. Here, the vertical wall portion includes the portion overlapping the intersection of the center line along the longitudinal direction of the door impact beam and the line segment connecting the second fixed portion of the first side portion and the second fixed portion of the second side portion of the two side portions in the vehicle side view. As a result, at the time of the side collision, the vertical wall portion can indirectly restrain a portion where stress is concentrated in the door impact beam, restrain the door impact beam from being largely deformed, and transmit the collision load satisfactorily.

In the vehicle side structure according to a fourth aspect, in the configuration according to any one of the first to third aspects, a rib connecting the vertical wall portion and the lower side frame portion is provided on an inner side surface of the vertical wall portion in a vehicle width direction, and at least a part of the rib is disposed at a position overlapping the end portion of the door impact beam in the longitudinal direction in the vehicle side view.

With the vehicle side structure according to the fourth aspect, in a case where the collision load is input to the rear side door at the time of the side collision, and the door impact beam that moves toward the vehicle cabin is supported by the vertical wall portion, the vertical wall portion can be restrained from falling toward the vehicle cabin by the rib. Therefore, it is possible to effectively restrain the door impact beam from moving toward the vehicle cabin at the time of the side collision.

As described above, with the vehicle side structure according to the present disclosure, an excellent effect of restraining the door impact beam from moving toward the vehicle cabin at the time of the side collision can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a rear frame body applied to a vehicle side structure according to an embodiment;

FIG. 2 is a side view showing a positional relationship between a rear portion and the like of a door impact beam and a part of the rear frame body with a side door body portion and the like in a state of being seen through;

FIG. 3 is a side view showing a part of a rear side of a vehicle in a vehicle front-rear direction to which the vehicle side structure according to the embodiment is applied; and

FIG. 4 is an enlarged sectional view cut along the line 4-4 in FIG. 3.

### DETAILED DESCRIPTION OF EMBODIMENTS

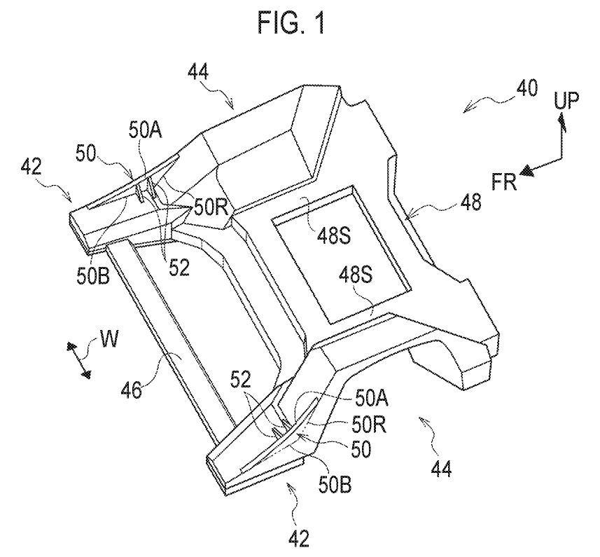

A vehicle side structure according to an embodiment of the present disclosure will be described with reference to FIGS. 1 to 4. In FIGS. 1 to 4, an arrow FR shown as appropriate indicates a vehicle front side, an arrow UP indicates a vehicle upper side, an arrow W indicates a vehicle width direction, and an arrow IN indicates an inner side of the vehicle width direction.

### Configuration of Embodiment

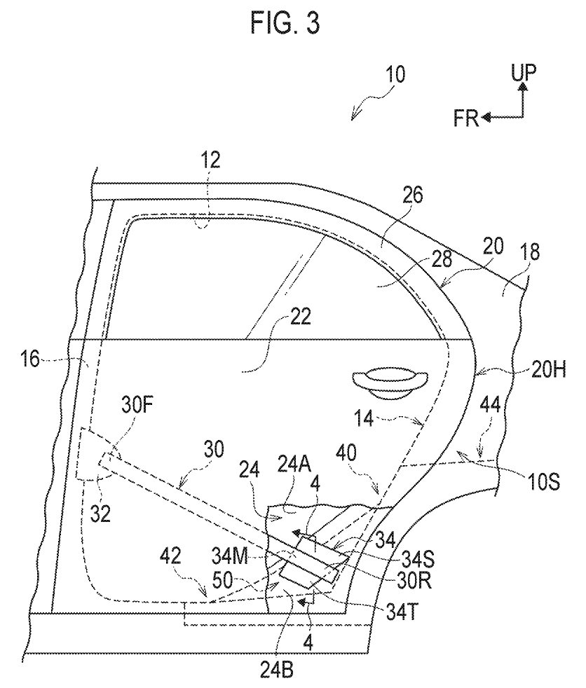

FIG. 3 shows a side view of a part of a rear side of a vehicle 10 in a vehicle front-rear direction to which a vehicle side structure according to the present embodiment is applied. As shown in FIG. 3, a rear side door opening portion 12 is provided on a rear side of a vehicle side portion 10S. The rear side door opening portion 12 communicates the inside of the vehicle cabin with the outside of the vehicle cabin, and is opened and closed by the rear side door 20. An outer surface of the vehicle 10 on an outer side of the vehicle width direction is constituted by a vehicle body outer panel 18.

The rear side door 20 is disposed on the vehicle side portion 10S and includes a side door body portion 20H as a body portion. As an example in the present embodiment, the side door body portion 20H is attached to a center pillar 16 that constitutes a part of the vehicle body by a door hinge (not shown), and is rotatable around a hinge pin of the door hinge. In the present embodiment, the rear side door 20 constitutes a so-called swing-type side door, but may constitute a so-called slide-type side door.

The side door body portion 20H includes a door outer panel 22 made of a metal (for example, steel) that is disposed on the outer side in the vehicle width direction in a door closed state and constitutes a door outer panel portion. A door inner panel 24 made of the metal (for example, steel) is disposed on the inner side of the door outer panel 22 in the vehicle width direction in the door closed state. In FIG. 3, a part of the door outer panel 22 is cut out to show the door inner panel 24. The door inner panel 24 constitutes a door inner panel portion of the side door body portion 20H.

A bulging portion 24A that bulges toward the vehicle cabin side and accommodates a window regulator (not shown) or the like is provided in the central portion of the door inner panel 24. In addition, in the door inner panel 24, a shelf portion 24B disposed in a substantially vehicle width direction as a plate thickness direction is formed on both sides in the vehicle front-rear direction and a vehicle lower side with respect to the bulging portion 24A. Edge portions of the door inner panel 24 on both sides in the vehicle front-rear direction and the vehicle lower side are joined to edge portions of the door outer panel 22 on both sides in the vehicle front-rear direction and the vehicle lower side by hemming. As a result, the side door body portion 20H having a bag shape in which an upper edge portion is opened is constituted by integrating the door outer panel 22 and the door inner panel 24.

In addition, a door window frame 26 of a frame-shaped body is provided on a vehicle upper side of the door outer panel 22. A windshield (side glass) 28 being able to appear and disappear from the side door body portion 20H is disposed in the door window frame 26 to be capable of being raised and lowered.

A door impact beam 30 extending along a vehicle front-rear direction is disposed in the side door body portion 20H of the rear side door 20. The door impact beam 30 of the present embodiment is slightly inclined toward the vehicle lower side toward the vehicle rear side in the vehicle side view. The door impact beam 30 is a member having high strength and high rigidity and is made of a member having a pipe shape.

A mounting bracket (also referred to as an “extension”) 32 as a bracket made of a sheet metal is fixed to a portion of a front end portion 30F that is a first end portion of the door impact beam 30 in the longitudinal direction, on the inner side in the vehicle width direction by welding. The mounting bracket 32 is fixed to a portion of the shelf portion 24B of the door inner panel 24 on the vehicle front side by welding, bolt fastening, or the like. That is, the front end portion 30F of the door impact beam 30 is fixed to the side door body portion 20H of the rear side door 20 via the mounting bracket 32.

Further, a mounting bracket (also referred to as an “extension”) 34 as a bracket made of a sheet metal is fixed to a portion of a rear end portion 30R that is a second end portion of the door impact beam 30 in the longitudinal direction, on the inner side in the vehicle width direction by welding. The mounting bracket 34 is fixed to a portion of the shelf portion 24B of the door inner panel 24 on the vehicle rear side by welding, bolt fastening, or the like. That is, the rear end portion 30R of the door impact beam 30 is fixed to the side door body portion 20H of the rear side door 20 via the mounting bracket 34.

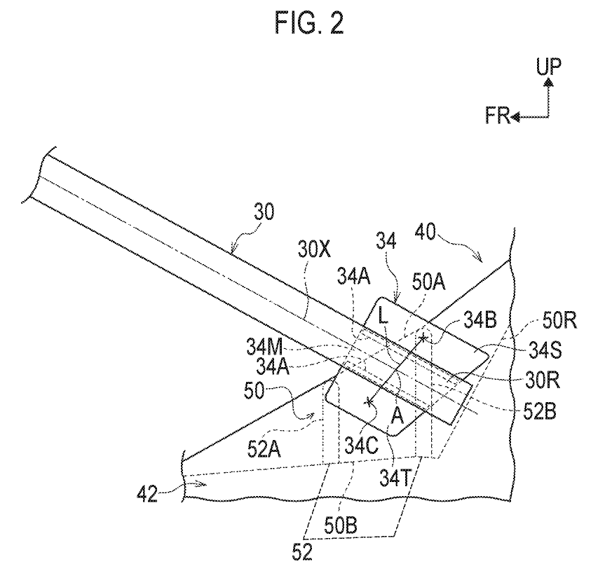

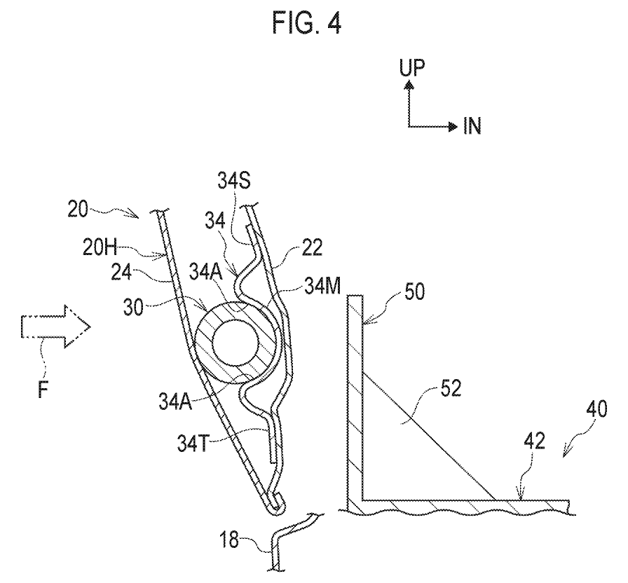

Here, the mounting bracket 34 will be described in more detail. The mounting bracket 34 includes a beam support portion 34M disposed at a position overlapping a part of the door impact beam 30 in the vehicle side view. FIG. 4 shows an enlarged sectional view cut along the line 4-4 in FIG. 3. In FIG. 4, for convenience, a portion of the vehicle body outer panel 18 that is disposed on the inner side in the vehicle width direction with respect to the rear side door 20 is not shown. As shown in FIG. 4, the beam support portion 34M is curved in an arc shape such that the surface on the door impact beam 30 side is curved along the outer peripheral surface of the door impact beam 30. The beam support portion 34M includes a first fixed portion 34A fixed to the door impact beam 30. A range of the first fixed portion 34A in the vehicle side view is shown in FIG. 2. As shown in FIGS. 3 and 4, the mounting bracket 34 includes side portions 34S, 34T that are disposed continuously with the beam support portion 34M on both sides of the door impact beam 30 in a direction intersecting the longitudinal direction (axial direction) in the vehicle side view. The side portions 34S, 34T include second fixed portions 34B, 34C (see FIG. 2 (in FIG. 2, for convenience, the positions of the second fixed portions 34B, 34C are indicated by “×”)) fixed to the side door body portion 20H of the rear side door 20.

As described above, the front end portion 30F and the rear end portion 30R of the door impact beam 30 are fixed to the side door body portion 20H of the rear side door 20 shown in FIG. 3. As a result, the rigidity of the side door body portion 20H of the rear side door 20 with respect to the load in the vehicle front-rear direction is improved.

A rear frame body 40 made by die casting is provided on a rear side of the vehicle side portion 10S. The rear frame body 40 includes a lower side frame portion 42 and a rear wheel house portion 44 provided on the rear side of the lower side frame portion 42 in the vehicle front-rear direction. Here, the lower side frame portion 42 constitutes a part of the lower portion (more specifically, a rear portion) of the rear side frame portion 14 that constitutes the rear side door opening portion 12.

FIG. 1 shows a perspective view of the rear frame body 40. In FIG. 1, the detailed shape of the rear frame body 40 is appropriately simplified. As shown in FIG. 1, the rear frame body 40 includes each of the lower side frame portion 42 and the rear wheel house portion 44 on both sides in the vehicle width direction. The lower side frame portion 42 extends along the vehicle front-rear direction. The rear wheel house portion 44 is provided continuously to the rear end portion side of the lower side frame portion 42. In addition, the rear frame body 40 includes a cross member (also referred to as a cross member portion) 46 that connects the right and left lower side frame portions 42 to each other in the vehicle width direction, and includes a connection frame portion 48 that connects the right and left rear wheel house portions 44 to each other in the vehicle width direction. The cross member 46 is provided in a beam shape, and is connected to the lower side frame portion 42 and extends along the vehicle width direction. The connection frame portion 48 is provided in a frame shape in plan view, and the right and left side component portions 48S are continuous with the rear wheel house portion 44.

FIG. 2 is a side view (a view seen from the outer side in the vehicle width direction) showing a positional relationship between the rear portion of the door impact beam 30 and the mounting bracket 34 and a part of the rear frame body 40 with the side door body portion 20H (see FIG. 3) and the like in a state of being seen through. As shown in FIGS. 1 and 2, the rear frame body 40 includes a vertical wall portion 50 erected from the lower side frame portion 42. As shown in FIG. 1, the vertical wall portion 50 is set to extend in the thickness direction along the vehicle width direction. A lower end portion 50B of the vertical wall portion 50 is continuous with the lower side frame portion 42, and the rear end portion 50R of the vertical wall portion 50 is continuous with, for example, the rear wheel house portion 44. In addition, in the left side of the vehicle right-left direction in FIG. 1, each of the positions of the lower end portion 50B and the rear end portion 50R of the vertical wall portion 50 on the outer side surfaces in the vehicle width direction is shown by the two-dot chain line for convenience. An upper end surface 50A of the vertical wall portion 50 is inclined toward the vehicle lower side in the vehicle front side as an example.

As shown in FIG. 2, the vertical wall portion 50 is disposed at a position overlapping the rear end portion 30R (one of the end portions of the door impact beam 30 in the longitudinal direction) of the door impact beam 30 in the vehicle side view. In addition, the vertical wall portion 50 is disposed at a position overlapping a part of the mounting bracket 34 (more than half in the present embodiment) in the vehicle side view. In addition, the vertical wall portion 50 includes a portion overlapping an intersection A of a center line 30X and a line segment L in the vehicle side view. The center line 30X is a line along the longitudinal direction of the door impact beam 30. The line segment L is a line segment connecting the second fixed portion 34B of a first side portion 34S and the second fixed portion 34C of a second side portion 34T of two side portions 34S, 34T of the mounting bracket 34.

As shown in FIGS. 1 and 2, a rib 52 connecting the vertical wall portion 50 and the lower side frame portion 42 is provided on the side surface of the vertical wall portion 50 on the inner side in the vehicle width direction. In the present embodiment, each of a plurality of the ribs 52 (for example, two) is provided to be arranged in the vehicle front-rear direction on both the right and left sides of the rear frame body 40. The rib 52 is set to extend in the vehicle front-rear direction along the plate thickness direction. The rib 52 is formed in a triangular shape, for example, as viewed from the vehicle front side, but may have another shape such as a square shape.

As shown in FIG. 2, a part of the rib 52 (52B) on a rear side is disposed at a position overlapping the rear end portion 30R (one of the end portions of the door impact beam 30 in the longitudinal direction) of the door impact beam 30 in the vehicle side view. As a modification of the present embodiment, the height of the front portion of the vertical wall portion 50 may be higher than the height shown in FIG. 2, and the height of the rib 52 (52A) on a front side in the vertical direction may be increased. Further, a part of the rib 52 (52A) on the front side may be disposed at a position overlapping the rear end portion 30R of the door impact beam 30 in the vehicle side view.

The lower side frame portion 42, the cross member 46, the vertical wall portion 50, the ribs 52, the rear wheel house portion 44, and the connection frame portion 48 shown in FIG. 1 are integrally formed by die casting of a metal material (for example, a light metal material such as an aluminum alloy material). The rear frame body 40 is a structure that can be grasped as a rear side gigacast.

### Action and Effect of Embodiment

Next, action and effect of the present embodiment will be described.

In the present embodiment, as shown in FIG. 3, the door impact beam 30 is disposed in the rear side door 20 and extends along the vehicle front-rear direction. In addition, the rear frame body 40 includes the lower side frame portion 42 and the vertical wall portion 50. Here, the lower side frame portion 42 constitutes a part of the lower portion of the rear side frame portion 14 that constitutes the rear side door opening portion 12. Here, the vertical wall portion 50 is erected from the lower side frame portion 42 and is disposed at a position overlapping the rear end portion 30R of the door impact beam 30 in the vehicle side view. At the time of the side collision, the collision load F may be input to the rear side door 20 shown in FIG. 4. In this case, the door impact beam 30 that moves toward the vehicle cabin side can be supported by the vertical wall portion 50, and the collision load transmitted from the door impact beam 30 side to the vertical wall portion 50 side can be transmitted to the lower side frame portion 42. Here, as shown in FIG. 1, the rear frame body 40 is further provided with a rear wheel house portion 44 provided on the vehicle rear side of the lower side frame portion 42, and is made by die casting. Therefore, it is possible to efficiently transmit a part of the collision load transmitted to the vertical wall portion 50 at the time of the side collision to the rear wheel house portion 44 side. As a result, it is possible to restrain the movement of the door impact beam 30 shown in FIG. 3 and the like to the vehicle cabin side at the time of the side collision.

In addition, in the present embodiment, the rear end portion 30R of the door impact beam 30 is fixed to the side door body portion 20H of the rear side door 20 via the mounting bracket 34 made of a sheet metal. As shown in FIG. 2, the vertical wall portion 50 is disposed at a position overlapping a part of the mounting bracket 34 (more than half in the present embodiment) in the vehicle side view. At the time of the side collision, the collision load may be input to the rear side door 20 shown in FIG. 3. In this case, since the load can be transmitted to the vertical wall portion 50 via the mounting bracket 34, it is possible to increase the area of the portion that transmits the load to the vertical wall portion 50, and the load transmission efficiency is improved.

In addition, in the present embodiment, as shown in FIG. 2, the beam support portion 34M of the mounting bracket 34 is disposed at a position overlapping a part of the door impact beam 30 in the vehicle side view, and includes the first fixed portion 34A. Here, the first fixed portion 34A is fixed to the door impact beam 30. The side portions 34S, 34T of the mounting bracket 34 are disposed on both sides of the door impact beam 30 in the direction intersecting the longitudinal direction in the vehicle side view, continuously with the beam support portion 34M, and include the second fixed portions 34B, 34C. Here, the second fixed portions 34B, 34C are fixed to the side door body portion 20H (see FIG. 3 for both) of the rear side door 20. Here, the vertical wall portion 50 includes a portion that overlaps the intersection A of the center line 30X and the line segment L along the longitudinal direction of the door impact beam 30 in the vehicle side view. Here, the line segment L is a line segment connecting the second fixed portion 34B of the first side portion 34S and the second fixed portion 34C of the second side portion 34T of the two side portions 34S, 34T. As a result, at the time of the side collision, the vertical wall portion 50 can indirectly restrain a portion where stress is concentrated in the door impact beam 30. Therefore, it is possible to restrain the door impact beam 30 from being largely deformed and to favorably transmit the collision load.

Further, in the present embodiment, as shown in FIGS. 1, 2, and 4, the rib 52 connecting the vertical wall portion 50 and the lower side frame portion 42 is provided on the side surface of the vertical wall portion 50 on the inner side in the vehicle width direction. As shown in FIG. 2, a part of the rib 52 (52B) on the rear side that is one of the ribs 52 is disposed at a position overlapping the rear end portion 30R of the door impact beam 30 in the vehicle side view. Therefore, in a case where the collision load is input to the rear side door 20 (see FIG. 3) at the time of the side collision, and the door impact beam 30 that moves to the vehicle cabin side is supported by the vertical wall portion 50, the vertical wall portion 50 can be restrained from falling toward the vehicle cabin side by the rib 52.

As described above, with the vehicle side structure according to the present embodiment, it is possible to restrain the door impact beam 30 from moving toward the vehicle cabin side at the time of the side collision.

In addition, in the present embodiment, the vertical wall portion 50 that is erected from the lower side frame portion 42 shown in FIG. 1 is provided. Therefore, the vertical wall portion 50 can restrain the front portion of the lower side frame portion 42 from being raised up due to the deformation of the rear wheel house portion 44 in the cooling process during die cast molding of the rear frame body 40.

### Supplemental Description of Embodiment

In the embodiment shown in FIGS. 1 to 4, the lower side frame portion 42 constitutes a lower portion of the rear side frame portion 14 that constitutes the rear side door opening portion 12. As a modification of the embodiment, for example, the lower side frame portion may constitute the entire lower portion of the rear side frame portion (14) that constitutes the rear side door opening portion (12). In addition, in a modification in which the lower side frame portion constitutes the entire lower portion of the rear side frame portion (14) that constitutes the rear side door opening portion (12), the vertical wall portion may be provided. The vertical wall portion is erected from the front portion of the lower side frame portion and is disposed at a position overlapping the front end portion of the door impact beam in the vehicle side view.

In addition, in the embodiment, the vertical wall portion 50 of the rear frame body 40 is disposed at a position overlapping a part of the mounting bracket 34 in the vehicle side view. As a modification of the embodiment, the vertical wall portion of the rear frame body may be disposed at a position where the entire mounting bracket 34 overlaps, for example, in the vehicle side view.

In addition, in the embodiment, the front end portion 30F and the rear end portion 30R that are the end portions of the door impact beam 30 in the longitudinal direction, are fixed to the side door body portion 20H of the rear side door 20 via the mounting brackets 32, 34 made of the sheet metal. As a modification of the embodiment, a configuration in which the end portion of the door impact beam in the longitudinal direction is directly fixed to the side door body portion (20H) of the rear side door (20) can also be adopted.

In addition, in the embodiment, the vertical wall portion 50 includes a portion that overlaps the intersection A of the center line 30X and the line segment L in the vehicle side view, and such a setting is preferable. The center line 30X is a center line along the longitudinal direction of the door impact beam 30. The line segment L is a line segment connecting the second fixed portion 34B of a first side portion 34S and the second fixed portion 34C of a second side portion 34T of the two side portions 34S, 34T of the mounting bracket 34. However, as a modification of the embodiment, a setting in which the vertical wall portion (50) does not include a portion overlapping the intersection (A) in the vehicle side view can be adopted.

In addition, in the embodiment, the first side portion 34S of the mounting bracket 34 includes one second fixed portion 34B, and the second side portion 34T has one second fixed portion 34C. However, each of the second fixed portions in the side portions (34S, 34T) may be plural.

In addition, in the embodiment, two ribs 52 connecting the vertical wall portion 50 and the lower side frame portion 42 are provided on the side surface of the vertical wall portion 50 on the inner side in the vehicle width direction. As a modification of the embodiment, a configuration in which one or three or more ribs (52) connecting the vertical wall portion (50) and the lower side frame portion (42) are provided on the side surface of the vertical wall portion (50) on the inner side in the vehicle width direction can be adopted. In addition, a configuration in which the ribs (52) are not provided can also be adopted.

In addition, in the embodiment, a part of the rib 52 (52B) on the rear side is disposed at a position overlapping the rear end portion 30R of the door impact beam 30 in the vehicle side view. As a modification of the embodiment, a configuration in which the entire rib (52) is disposed at a position overlapping the end portion (rear end portion 30R) of the door impact beam (30) in the longitudinal direction in the vehicle side view can also be adopted.

The embodiments and the modifications can be appropriately combined and implemented.

Although an example of the present disclosure has been described above, the present disclosure is not limited to the above, and can be variously modified and implemented within the scope not deviating the spirit of the present disclosure.

What is claimed is:

1. A vehicle side structure comprising:
a door impact beam disposed in a rear side door that opens and closes a rear side door opening portion and extending along a vehicle front-rear direction; and
a rear frame body made by die casting, the rear frame body including a lower side frame portion constituting at least a part of a lower portion of a rear side frame portion that constitutes the rear side door opening portion, a vertical wall portion erected from the lower side frame portion and disposed at a position overlapping an end portion of the door impact beam in a longitudinal direction in a vehicle side view, and a rear wheel house portion provided rearward of the lower side frame portion in the vehicle front-rear direction.

2. The vehicle side structure according to claim 1, wherein:
the end portion of the door impact beam in the longitudinal direction is fixed to a body portion of the rear side door via a bracket made of a sheet metal; and
the vertical wall portion is disposed at a position overlapping at least a part of the bracket in the vehicle side view.

3. The vehicle side structure according to claim 2, wherein:
the bracket includes a beam support portion disposed at a position overlapping a part of the door impact beam in the vehicle side view and including a first fixed portion fixed to the door impact beam, and side portions disposed continuously with the beam support portion, the side portions being each disposed on a corresponding one of both sides of the door impact beam in a direction intersecting the longitudinal direction in the vehicle side view, and including a second fixed portion fixed to the body portion of the rear side door; and
the vertical wall portion includes a portion overlapping an intersection of a center line along the longitudinal direction of the door impact beam and a line segment connecting the second fixed portion of a first side portion and the second fixed portion of a second side portion of the two side portions in the vehicle side view.

4. The vehicle side structure according to claim 1, wherein:
a rib connecting the vertical wall portion and the lower side frame portion is provided on an inner side surface of the vertical wall portion in a vehicle width direction; and
at least a part of the rib is disposed at a position overlapping the end portion of the door impact beam in the longitudinal direction in the vehicle side view.
